(19) United States
(12) Patent Application Publication
(10) Pub. No.: US 2025/0055164 A1
(43) Pub. Date: Feb. 13, 2025

(54) BATTERY MODULE

(71) Applicant: Sungrow Power Supply Co., Ltd., Hefei (CN)

(72) Inventor: Maochao Wu, Hefei (CN)

(73) Assignee: Sungrow Power Supply Co., Ltd., Hefei (CN)

(21) Appl. No.: 18/645,846

(22) Filed: Apr. 25, 2024

(30) Foreign Application Priority Data
Dec. 8, 2023 (CN) 202323361958.7

(51) Int. Cl. H01M 50/59; H01M 50/209; H01M 50/289; H01M 50/588

(52) U.S. Cl. CPC H01M 50/59; H01M 50/209; H01M 50/289; H01M 50/588

(57) ABSTRACT

A battery module includes multiple battery units sequentially arranged along a thickness direction and a protection assembly. The battery unit includes a housing having an accommodation cavity, and a battery cell is arranged in the accommodation cavity. The protection assembly is provided between two adjacent battery units, where one end of the protection assembly is located in an accommodation cavity of one of the two adjacent battery units, the other end of the protection assembly is located in an accommodation cavity of the other one of the two adjacent battery units. The protection assembly is a hollow structure, and the accommodation cavities of the two adjacent battery units are communicated by the protection assembly, where a connecting wire passes through the protection assembly.

### CROSS REFERENCE TO RELATED APPLICATIONS

This application claims the priority to Chinese Patent Application No. 202323361958.7 titled “BATTERY MODULE”, filed with the China National Intellectual Property Administration on Dec. 8, 2023, which is incorporated herein by reference in its entirety.

### FIELD

The present application relates to the technical field of energy storage equipment, and in particular to a battery module.

### BACKGROUND

At present, in photovoltaic power generation and other energy storage systems, a battery module is generally used for energy storage. The battery module includes multiple battery units, and the multiple battery units are connected in series or in parallel by connecting wires.

In the battery module of the prior art, when the battery units are connected, a connecting rack or a housing is usually used to connect and fix the multiple battery units, and the multiple battery units are connected by the connecting wires at the same time. With this fixation manner, the number of the battery units being connected at the same time is fixed, and the connecting wires are apt to be affected by environment and thus be damaged in use, which causes the battery module not able to work normally.

### SUMMARY

A battery module is provided in the present application, to solve the problem that a connecting wire of the battery module in the prior art is apt to be damaged.

A battery module is provided in the present application, including multiple battery units and a protection assembly, where
the multiple battery units are sequentially arranged along a thickness direction, each of the multiple battery units includes a housing having an accommodation cavity, and a battery cell is arranged in the accommodation cavity; and
the protection assembly is provided between two adjacent battery units, where one end of the protection assembly is located in an accommodation cavity of one of the two adjacent battery units, the other end of the protection assembly is located in an accommodation cavity of the other one of the two adjacent battery units, the protection assembly is a hollow structure, and the accommodation cavities of the two adjacent battery units are communicated by the protection assembly, where the protection assembly is configured for a connecting wire to pass through.

In an embodiment, the protection assembly includes a connecting structure, and the two adjacent battery units are connected by the connecting structure.

In an embodiment, the connecting structure includes a connecting tube and a fastener, each of the accommodation cavities has a first side wall and a second side wall spaced apart in the thickness direction of the battery units; the connecting tube passes through the first side wall of one of the two adjacent battery units and the second side wall of the other one of the two adjacent battery units; and the fastener is provided in the accommodation cavity of at least one of the two adjacent battery units and cooperates with the connecting tube to make the two adjacent battery units be fixedly connected with each other.

In an embodiment, the connecting tube is provided with a through hole, and the through hole forms the hollow structure.

In an embodiment, the connecting tube includes a first end and a second end, a limiting structure is provided at the first end, and a threaded structure is provided at the second end, where the fastener is a nut, and the fastener is connected to the threaded structure by a threaded fit.

In an embodiment, the limiting structure includes a limiting protrusion, the first side wall is provided with a first through hole, the second side wall is provided with a second through hole, the first through hole and the second through hole are arranged facing each other, and the connecting tube passes through the first through hole and the second through hole, where the limiting protrusion is fitted with the first through hole to prevent displacement of the connecting tube with respect to the two adjacent battery units.

In an embodiment, the limiting structure further includes multiple rotation-stopping protrusions provided spaced apart on an outer wall of the connecting tube along a circumferential direction; and multiple first accommodation notches are provided on a wall of the first through hole, and are arranged in one-to-one correspondence with the multiple rotation-stopping protrusions, to match the multiple rotation-stopping protrusions to prevent rotation of the connecting tube with respect to the two adjacent battery units.

In an embodiment, the protection assembly further includes a support tube sleeved on the connecting tube, the support tube is arranged between the two adjacent battery units; one end of the support tube abuts against the first side wall of the one of the two adjacent battery units, the other end of the support tube abuts against the second side wall of the other one of the two adjacent battery units, where multiple second accommodation notches are provided at the other end of the support tube abutting against the second side wall, another multiple rotation-stopping protrusions are provided on the outer wall of the of the connecting tube in one-to-one correspondence with the multiple second accommodation notches, and the multiple rotation-stopping protrusions are located in the first accommodation notches and the another multiple rotation-stopping protrusions are located in the second accommodation notches respectively, to prevent rotation of the support tube with respect to the two adjacent battery units.

In an embodiment, the accommodation cavity includes a placement cavity and a mounting cavity; the battery cell is placed in the placement cavity, the mounting cavity has an opening on a side wall of the housing, the hollow structure of the protection assembly is in communication with the mounting cavity; and the number of the mounting cavity in each of the multiple battery units is two, and the two mounting cavities are arranged at two sides of the housing in a width direction of the housing.

In an embodiment, the number of the protection assembly provided between the two adjacent battery units is plural.

With the above technical solutions, the battery module includes multiple battery units and a protection assembly, where the protection assembly is a hollow structure, and accommodation cavities of two adjacent battery units can be communicated with each other by the protection assembly. In this way, a connecting wire between the two adjacent battery units can pass through the protection assembly, and is protected by the protection assembly, which prevents the connecting wire from being damaged in use of the battery module, thereby improving the durability of the battery module.

### BRIEF DESCRIPTION OF THE DRAWINGS

The accompanying drawings constituting a part of the present application are used for providing further understanding of the present application. Exemplary embodiments of the present application and description thereof are used for illustrating the present application, and are not intended to form an improper limit to the present application.

FIG. 1 is a schematic view showing the structure of a battery module according to the present application;

FIG. 2 is a partially enlarged view of a portion A in FIG. 1;

FIG. 3 is a schematic view showing the structure of a connecting tube according to the present application;

FIG. 4 is a schematic view showing the structure of a fastener according to the present application;

FIG. 5 is a schematic view showing the structure of a battery unit according to the present application;

FIG. 6 is a partially enlarged view of a portion B in FIG. 5;

FIG. 7 is a schematic view showing the structure of battery units being fitted with a support tube according to the present application;

FIG. 8 is a partially enlarged view of a portion C in FIG. 7; and

FIG. 9 is a schematic view showing the structure of the support tube according to the present application.

Reference numerals are as follows.

| | | | |
|---|---|---|---|
| 100 | battery unit, | 110 | first side wall, |
| 111 | first through hole, | 112 | first accommodation |
| 120 | second side wall, | 121 | second through hole, |
| 200 | protection assembly, | 210 | connecting tube, |
| 220 | fastener, | 230 | limiting protrusion, |
| 240 | rotation-stopping protrusion, | 250 | support tube, |
| 251 | second accommodation notch, | 300 | mounting cavity. |

### DETAILED DESCRIPTION OF THE EMBODIMENTS

Technical solutions according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of protection of the present application.

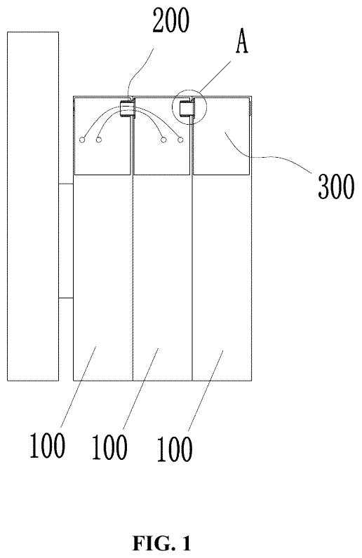

As shown in FIG. 1, a battery module is provided in the embodiments of the present application, including a battery unit 100 and a protection assembly 200. The number of the battery unit 100 is plural, and the plurality of battery units 100 are sequentially arranged along a thickness direction. Each of the plurality of battery units 100 includes a housing, the housing includes an accommodation cavity, and a battery cell is arranged in the accommodation cavity. The protection assembly 200 is arranged between two adjacent battery units 100, where one end of the protection assembly 200 is located in an accommodation cavity of one of the two adjacent battery units 100, and the other end of the protection assembly 200 is located in an accommodation cavity of the other one of the two adjacent battery units 100. The protection assembly 200 is a hollow structure, and the accommodation cavities of the two adjacent battery units 100 are communicated by the protection assembly 200, where a connecting wire passes through the protection assembly 200.

With the technical solution of the present application, the battery module includes multiple battery units 100 and a protection assembly 200, where the protection assembly 200 is a hollow structure, and accommodation cavities of two adjacent battery units 100 can be communicated with each other by the protection assembly 200. In this way, a connecting wire between the two adjacent battery units 100 can pass through the protection assembly 200, and is protected by the protection assembly 200, which prevents the connecting wire from being damaged in use of the battery module, thereby improving the durability of the battery module.

In an embodiment, the protection assembly 200 further includes a connecting structure, and the two adjacent battery units 100 are connected by the connecting structure. Energy storage performance of the battery module is determined by the number of the battery units, and each two adjacent battery units 100 can be connected by the protection assembly 200. With the above arrangements, a battery unit 100 can be added to the original battery module through the connecting structure of the protection assembly 200 to expand capacity of the battery module. Specifically, in a case that the energy storage performance of the battery module needs to be improved, based on the multiple battery units 100 of the original battery module, an additional protection assembly 200 can be newly added, and then an additional battery unit 100 can be connected to the original battery module via the additional protection assembly 200, to expand the capacity of the battery module. Correspondingly, in a case that the number of the battery units 100 in the battery module needs to be decreased, the number of the battery units 100 and the number of the protection assemblies 200 can be reduced, to adjust the energy storage performance of the battery module, which facilitates adjustment to the battery module according to different demands for energy storage.

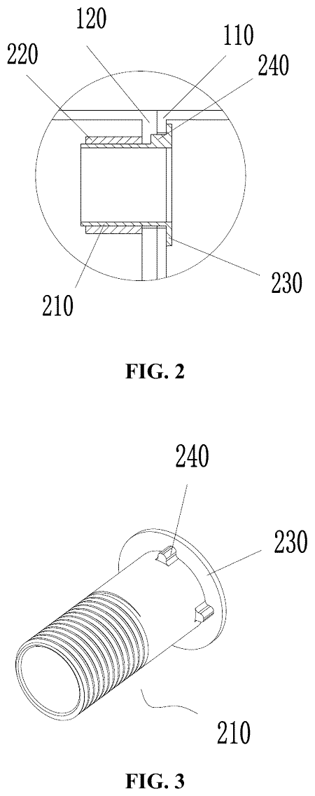

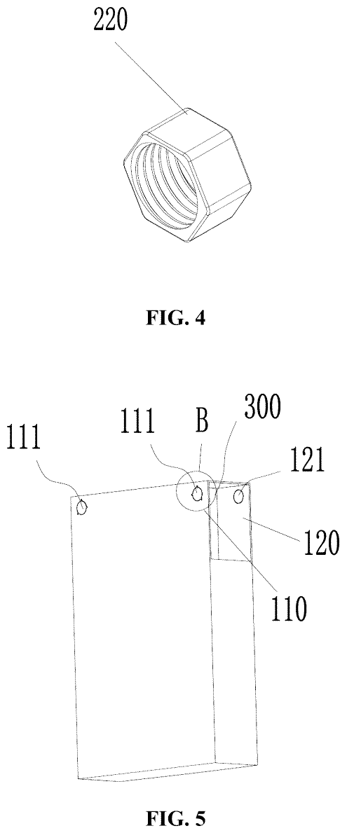

Referring to FIGS. 2 to 4, the connecting structure includes a connecting tube 210 and a fastener 220. Each accommodation cavity has a first side wall 110 and a second side wall 120 arranged spaced apart from each other along the thickness direction of the battery unit 100, and the connecting tube 210 passes through a first side wall 110 of one of the two adjacent battery units 100 and a second side wall 120 of the other one of the two adjacent battery units 100. The fastener 220 is arranged in the accommodation cavity of at least one of the two adjacent battery units 100 and cooperates with the connecting tube 210 to fixedly connect the two adjacent battery units 100. With the above arrangements, the connecting tube 210 can accommodate the connecting wire between the two adjacent battery units 100, and the connecting tube 210 and the fastener 220 form the connecting structure to connect the two adjacent battery units 110 to expand the capacity of the battery module.

Specifically, the connecting tube 210 is provided with a through hole, so as to form the hollow structure. After the two adjacent battery units 100 are connected to each other, the connecting wire passes through the through hole, and the connecting tube 210 can protect the connecting wire.

In a further embodiment, the connecting tube 210 includes a first end and a second end, a limiting structure is provided at the first end, and a threaded structure is provided at the second end. The fastener 220 is a nut, and the fastener 220 is connected to the threaded structure by a threaded fit. With the above arrangements, the limiting structure cooperates with the fastener 220 to prevent the two adjacent battery units 100 from getting away from or close to each other, thus achieves an effect of fixing the two adjacent battery units 100, such that the two adjacent battery units 100 can be connected stably.

Specifically, the limiting structure includes a limiting protrusion 230. A first through hole 111 is provided in the first side wall 110, a second through hole 121 is provided in the second side wall 120, where the first through hole 111 and the second through hole 121 are arranged in correspondence, and the connecting tube 210 passes through the first through hole 111 and the second through hole 121. The limiting protrusion 230 is fitted with the first through hole 111 to prevent a displacement of the connecting tube 210 with respect to the two adjacent battery units 100. Specifically, a diameter of the limiting protrusion 230 is larger than a diameter of the first through hole 111 and a diameter of the second through hole 121. In this way, the limiting protrusion 230 cannot pass through the first through hole 111 and the second through hole 121, thereby achieving a limiting effect. The limiting protrusion 230 may be arranged at an outer wall of the connecting tube 210 in an annular manner. In this way, the limiting protrusion 230 will not cover the through hole of the connecting tube 210, thus the connecting wire can pass through the connecting tube 210.

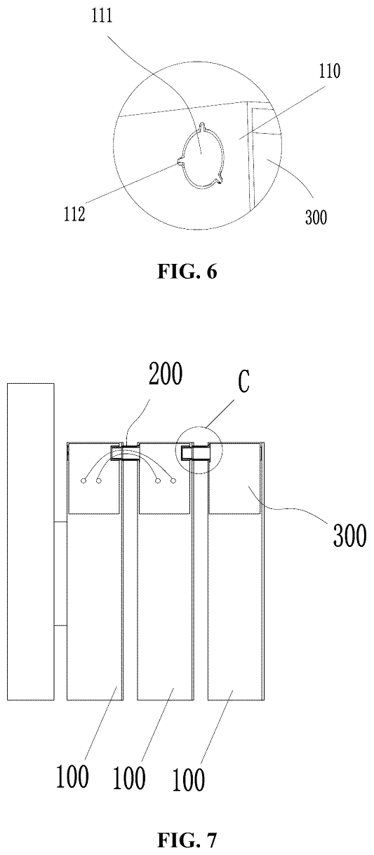

Referring to FIGS. 5 and 6, the limiting structure further includes a rotation-stopping protrusion 240, the number of the rotation-stopping protrusion 240 is plural, and the multiple rotation-stopping protrusions 240 are annularly spaced apart on an outer wall of the connecting tube 210 along a circumferential direction. A first through hole 111 is provided in the first side wall 110, a second through hole 121 is provided in the second side wall 120, where the first through hole 111 and the second through hole 121 are arranged in correspondence, and the connecting tube 210 passes through the first through hole 111 and the second through hole 121. Multiple first accommodation notches 112 are provided on a wall of the first through hole 111, and the multiple first accommodation notches 112 and the multiple rotation-stopping protrusions 240 are arranged in one-to-one correspondence. The multiple first accommodation notches 112 match the multiple rotation-stopping protrusions 240 to limit rotation of the connecting tube 210 with respect to the two adjacent battery units 100.

In a specific embodiment of the present application, a side wall of the second through hole 121 is also provided with accommodation notches. The first through hole 111 and the second through hole 121 match the rotation-stopping protrusions 240 for limitation at the same time, to further improve limiting performance of the limiting structure, and thereby ensuring connection stability of the connecting structure.

In another specific embodiment of the present application, both ends of the connecting tube 210 are each provided with a fastener 220 to fix the two adjacent battery units 100, which improves the connecting performance between the two adjacent battery units 100.

In the above embodiments, in a case that the two adjacent battery units 100 are connected, the first side wall 110 and the second side wall 120 are connected by the connecting structure in an abutting manner. In this way, overall volume occupation of the battery module is reduced, and energy density of the battery module is increased.

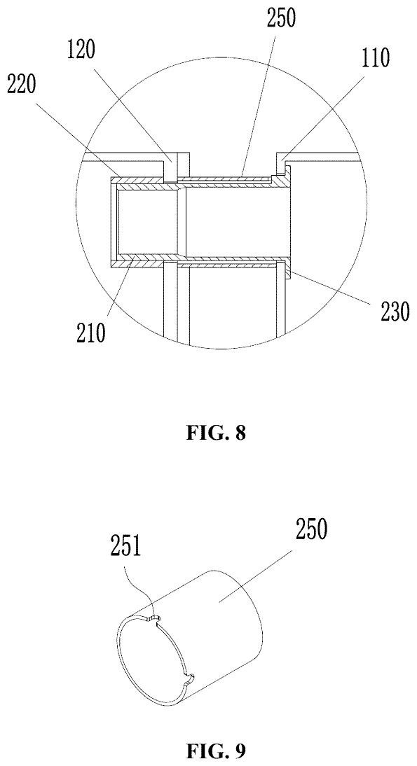

Referring to FIGS. 7 to 9, in yet another specific embodiment of the present application, the protection assembly 200 further includes a support tube 250. The support tube 250 is sleeved on the connecting tube 210, and the support tube 250 is arranged between the two adjacent battery units 100. One end of the support tube 250 abuts against the first side wall 110 of the one of the two adjacent battery units 100, and the other end of the support tube 250 abuts against the second side wall 120 of the other one of the two adjacent battery units 100. Multiple second accommodation notches 251 are provided at the other end of the support tube abutting against the second side wall 120. Another multiple rotation-stopping protrusions 240 are provided on the outer wall of the of the connecting tube in one-to-one correspondence with the multiple second accommodation notches 251, and the multiple rotation-stopping protrusions 240 are located in the first accommodation notch 112 and the another multiple rotation-stopping protrusions are located in second accommodation notch 251 respectively, to prevent the support tube 250 from rotating with respect to the two adjacent battery units 100. With the above arrangements, a distance between the two adjacent battery units 100 can be determined by the support tube 250, which facilitates design of the size of the battery module to satisfy using requirements in different situations. Specifically, a support tube 250 may be added between each two adjacent battery units 100, or a support tube 250 may be selectively added between at least two adjacent battery units 100, so that the overall size of the battery module can be flexibly adjusted. The multiple second accommodation notches 251 match the another multiple rotation-stopping protrusions 240, which can prevent the support tube 250 from rotating between the two adjacent battery units 100, so as to avoid the stability of connection between the protection assembly 200 and the battery units 100 from being affected, and thereby ensuring overall stability of the battery module.

In the present application, the accommodation cavity includes a placement cavity and a mounting cavity 300. The battery cell is placed in the placement cavity. The mounting cavity 300 has an opening located on a side wall of the housing. The hollow structure of the protection assembly 200 is in communication with the mounting cavity 300. Each of the multiple battery units 100 includes two mounting cavities 300 arranged at two sides of the housing in a width direction of the housing. With the above arrangements, the opening is provided on the side wall of the housing to form an operation space, which facilitates mounting of the connecting structure and connection of the connecting wire, and improves the convenience of mounting. The two mounting cavities 300 arranged at the two sides of the housing may be specifically arranged along the width direction of the housing, and mounting positions can be selected. For example, the connecting structure may be mounted at one side of the housing or each of both sides of the housing. The specific mounting manner may be adjusted according to wiring design, which is more beneficial to the wiring design of the battery module.

Specifically, multiple protection assemblies 200 are provided between the two adjacent battery units 100. With the above arrangements, multiple protection assemblies 200 are provided between the two adjacent battery units 100, and the multiple protection assemblies 200 protect the connecting wire at the same time. In this way, circuit design of the battery module is facilitated. The two adjacent battery units 100 are connected by the multiple protection assemblies 200 at the same time, which improves the connecting performance between the two adjacent battery units 100, and further improves the overall stability of the battery module.

Further, in a case that multiple protection assemblies 200 are provided between the two adjacent battery units 100, fasteners 200 of the multiple protection assemblies 200 are all arranged in the accommodation cavity of the same battery unit 100 of the two adjacent battery units 100, which facilitates mounting of the protection assemblies 200, and improves the mounting efficiency.

It should be noted that, terms used herein are only for describing specific implementations, and are not intended to limit exemplary implementations according to this application. As used herein, the singular form is intended to include the plural form, unless otherwise explicitly indicated in the context. In addition, it should be further understood that terms “include” and/or “comprise” used in this specification indicate that there are features, steps, operations, devices, assemblies, and/or combinations thereof.

Unless otherwise stated specifically, relative arrangements of the components and steps, the numerical expressions, and the values set forth in the embodiments are not intended to limit the scope of the present application. Meanwhile, it should be understood that, in order to facilitate descriptions, sizes of respective parts shown in the accompanying drawings are not drawn according to an actual proportional relationship. Technologies, methods and devices known to those skilled in the art may not be discussed in detail, but such technologies, methods and devices should be considered as a part of the specification in appropriate situations. In all the examples shown and discussed herein, any specific value should be construed as merely illustrative and not as a limitation. Therefore, other examples of exemplary embodiments may have different values. It should be noted that, similar reference numerals and letters in the following drawings indicate similar items. Therefore, once an item is defined in a drawing, the item does not need to be further discussed in the subsequent drawings.

In the description of the present application, it should be noted that the orientation or positional relationships indicated by terms such as “front”, “rear”, “up”, “down”, “left”, “right”, “lateral”, “vertical”, “perpendicular”, “horizontal”, “top”, “bottom”, and the like are based on the orientation or positional relationships shown in the drawings, and are merely for the convenience of describing the present application and the simplification of the description. Unless otherwise stated to the contrary, these orientation terms do not indicate or imply that the device or element referred to must have a particular orientation, or be configured and operated in a particular orientation, which therefore should not be construed as a limitation to the protection scope of the present application. The orientation terms such as “inner”, “outer” refer to an interior and exterior with respect to the outline of each component itself.

For the convenience of description, spatially relative terms such as “on”, “over”, “on the upper surface of”, “above” or the like can be used herein to describe the spatial positional relationship between a component or feature and another component or feature as shown in the drawings. It should be understood that spatially relative terms are intended to encompass different orientations in use or operation in addition to the orientation of the component depicted in the drawings. For example, if the components in the drawings are inverted, components described as “above another component or structure” or “on another component or structure” will be positioned as “under another component or structure” or “below another component or structure”. Thus, the exemplary term “above” can include both directions of “above” and “below”. The component can also be positioned in other different positions (rotated by 90 degrees or in other orientations), and the spatial relative description used herein is explained accordingly.

In addition, it should be noted that the terms “first” and “second” used to define parts are merely for the convenience of distinguishing the corresponding parts. Unless otherwise stated, the above terms have no special meaning, which therefore should not be construed as a limitation to the protection scope of the present application.

The above descriptions are merely preferred embodiments of the present application, and are not used to limit the scope of the present application. For those skilled in the art, various modifications and variations may be made to the present application. Any modifications, equivalent replacements and improvements made to the present application within the principle of the present application are deemed to fall into the protection scope of the present application.

1. A battery module, comprising a plurality of battery units and a protection assembly, wherein
the plurality of battery units are sequentially arranged along a thickness direction, each of the plurality of battery units comprises a housing having an accommodation cavity, and a battery cell is arranged in the accommodation cavity; and
the protection assembly is provided between two adjacent battery units of the plurality of battery units, wherein one end of the protection assembly is located in an accommodation cavity of one of the two adjacent battery units, the other end of the protection assembly is located in an accommodation cavity of the other one of the two adjacent battery units, the protection assembly is a hollow structure, and the accommodation cavities of the two adjacent battery units are communicated by the protection assembly, wherein the protection assembly is configured for a connecting wire to pass through.

2. The battery module according to claim 1, wherein the protection assembly comprises a connecting structure, and the two adjacent battery units are connected by the connecting structure.

3. The battery module according to claim 2, wherein
the connecting structure comprises a connecting tube and a fastener, each of the accommodation cavities has a first side wall and a second side wall spaced apart in the thickness direction of the battery units;
the connecting tube passes through the first side wall of one of the two adjacent battery units and the second side wall of the other one of the two adjacent battery units; and
the fastener is provided in the accommodation cavity of at least one of the two adjacent battery units and cooperates with the connecting tube to make the two adjacent battery units be fixedly connected with each other.

4. The battery module according to claim 3, wherein the connecting tube is provided with a through hole, and the through hole forms the hollow structure.

5. The battery module according to claim 3, wherein the connecting tube comprises a first end and a second end, a limiting structure is provided at the first end, and a threaded structure is provided at the second end, wherein the fastener is a nut, and the fastener is connected to the threaded structure by a threaded fit.

6. The battery module according to claim 5, wherein
the limiting structure comprises a limiting protrusion; and
the first side wall is provided with a first through hole, the second side wall is provided with a second through hole, the first through hole and the second through hole are arranged facing each other, and the connecting tube passes through the first through hole and the second through hole; wherein
the limiting protrusion is fitted with the first through hole to prevent displacement of the connecting tube with respect to the two adjacent battery units.

7. The battery module according to claim 6, wherein
the limiting structure further comprises a plurality of rotation-stopping protrusions, the plurality of rotation-stopping protrusions are provided on an outer wall of the connecting tube along a circumferential direction; and
a plurality of first accommodation notches are provided on a wall of the first through hole, and are arranged in one-to-one correspondence with the plurality of rotation-stopping protrusions, to match the plurality of rotation-stopping protrusions to prevent rotation of the connecting tube with respect to the two adjacent battery units.

8. The battery module according to claim 7, wherein
the protection assembly further comprises a support tube sleeved on the connecting tube, the support tube is arranged between the two adjacent battery units; and
one end of the support tube abuts against the first side wall of the one of the two adjacent battery units, the other end of the support tube abuts against the second side wall of the other one of the two adjacent battery units; wherein
a plurality of second accommodation notches are provided at the other end of the support tube abutting against the second side wall, another plurality of rotation-stopping protrusions are provided on the outer wall of the of the connecting tube in one-to-one correspondence with the plurality of second accommodation notches, the plurality of rotation-stopping protrusions are located in the first accommodation notches and the another plurality of rotation-stopping protrusions are located in the second accommodation notches, to prevent rotation of the support tube with respect to the two adjacent battery units.

9. The battery module according to claim 1, wherein
the accommodation cavity comprises a placement cavity and a mounting cavity;
the battery cell is placed in the placement cavity, the mounting cavity has an opening on a side wall of the housing, the hollow structure of the protection assembly is in communication with the mounting cavity; and
the number of the mounting cavity in each of the plurality of battery units is two, and the two mounting cavities are arranged at two sides of the housing in a width direction of the housing.

10. The battery module according to claim 1, wherein the number of the protection assembly provided between the two adjacent battery units is plural.
